(19) United States
(12) Patent Application Publication
(10) Pub. No.: US 2022/0185979 A1
(43) Pub. Date: Jun. 16, 2022

(54) RESIN FOAM BODY AND FOAM MEMBER

(71) Applicant: NITTO DENKO CORPORATION, Ibaraki-shi, Osaka (JP)

(72) Inventors: Kiyoaki KODAMA, lbaraki-shi (JP); Makoto SAITO, Ibaraki-shi (JP)

(73) Assignee: NITTO DENKO CORPORATION, Ibaraki-shi, Osaka (JP)

(21) Appl. No.: 17/600,215

(22) PCT Filed: Apr. 10, 2020
(86) PCT No.: PCT/JP2020/016083

§ 371 Date: Sep. 30, 2021

(30) Foreign Application Priority Data
Apr. 10, 2019 (JP) 2019-074692

(51) Int. Cl. C08J 9/00; C08J 9/36; C09J 7/26

(52) U.S. Cl. CPC C08J 9/0061; C08J 9/0023; C08J 9/0066; C08J 2323/18; C09J 7/26; C08J 2205/044; C08J 2323/12; C08J 9/36

(57) ABSTRACT

Provided is a resin foam which has high stress dispersibility and is excellent in heat resistance. The resin foam of the present invention is a resin foam having a cell structure, wherein the resin foam has an apparent density of from 0.05 g/cm³ to 0.50 g/cm³, wherein the resin foam has a 50% compression load of from 2.0 N/cm² to 30 N/cm², and wherein the resin foam has an apparent density D (g/cm³) and a residue R (%) at 650° C. satisfying a relationship of the following expression (1).

1≤{(100−R)/D}/100≤10 (1)

### TECHNICAL FIELD

The present invention relates to a resin foam and a foam member.

### BACKGROUND ART

A foam is used in order to protect members such as a battery and a substrate of a mobile device. However, in recent years, the processing speed has been increased due to high-capacity data communication, combined use of applications, and the like, and each member is liable to generate heat. Accordingly, the foam is required to withstand the long-term use at high temperature.

As a method of forming a foam excellent in heat resistance, a method of forming a foam through use of a resin having a high melting point (for example, 150° C. or more) is conceivable. However, when a chemical foaming agent (for example, a thermal decomposition-type foaming agent) is added to impart foamability, foaming may occur at the molding temperature of the resin having a high melting point, and hence it is difficult to obtain a foam through use of the resin having a high melting point.

Meanwhile, in recent years, regarding the size of a clearance in a portion in which a foam is used, there has been a demand for a material adaptable to a smaller clearance. In addition, when the foam is applied to a mobile device, an unexpected load is liable to be applied to each member due to the fall of the device or the external application of a pressure. Accordingly, when such load can be effectively dispersed in stress, the impact can be absorbed to prevent an electronic device from being broken by the unexpected load. For the above-mentioned reason, there is a demand for a foam which is adaptable to a smaller clearance and has stress dispersibility at a higher level.

As a method of obtaining a foam without using a chemical foaming agent, there has been investigated a method involving dissolving an inert gas in a polymer under high pressure and then abruptly decreasing the pressure to form a foam structure. For example, in Patent Literature 1, there is disclosed a method involving loading a thermoplastic polymer into a pressure vessel, loading a high-pressure gas into the pressure vessel while heating the polymer to its softening point, and then decreasing the pressure to form cells. However, although the foam of Patent Literature 1 has flexibility to some extent, the foam does not have heat resistance. In addition, in Patent Literature 1, there is no disclosure or suggestion regarding stress dispersibility (impact absorbability) of the foam.

In addition, in Patent Literature 2, there is disclosed a method of imparting heat resistance to a polyolefin-based foam by selecting a polyolefin resin or a thermoplastic elastomer having a specific melting point. However, in Patent Literature 2, there is no disclosure or suggestion regarding stress dispersibility (impact absorbability) of the foam.

### CITATION LIST

### Patent Literature

[PTL 1] JP 06-322168 A

[PTL 2] JP 2013-082881 A

### SUMMARY OF INVENTION

### Technical Problem

An object of the present invention is to provide a resin foam which has high stress dispersibility and is excellent in heat resistance.

### Solution to Problem

According to one embodiment of the present invention, there is provided a resin foam having a cell structures, wherein the resin foam has an apparent density of from 0.05 g/cm³ to 0.50 g/cm³, wherein the resin foam has a 50% compression load of from 2.0 N/cm² to 30 N/cm², and wherein the resin foam has an apparent density D (g/cm³) and a residue R (%) at 650° C. satisfying a relationship of the following expression (1).

1≤{(100−R)/D}/100≤10 (1)

In one embodiment, the cell structures have an average cell diameter of from 10 μm to 200 μm.

In one embodiment, the cell structures have a coefficient of variation in cell diameter of 0.5 or less.

In one embodiment, the cell structure has a cell ratio of 30% or more.

In one embodiment, the cell structure has a thickness of a cell wall of from 0.1 μm to 10 μm.

In one embodiment, the resin foam has a tensile modulus of elasticity at 23° C. of 0.6 MPa or more.

In one embodiment, the resin foam has a stress retentivity of 60% or more.

In one embodiment, the resin foam contains a filler.

In one embodiment, the filler is an inorganic substance.

In one embodiment, the filler is an organic substance.

In one embodiment, a resin forming the resin foam is a polyolefin-based resin.

In one embodiment, the polyolefin-based resin is a mixture of polypropylene other than a polyolefin-based elastomer and the polyolefin-based elastomer.

In one embodiment, the resin foam has a hot-melt layer on one surface or both surfaces thereof.

According to another embodiment of the present invention, there is provided a foam member. The foam member includes: a resin foam layer formed of the above-mentioned resin foam; and a pressure-sensitive adhesive layer arranged on at least one side of the resin foam layer.

### Advantageous Effects of Invention

According to the present invention, the resin foam, which has high stress dispersibility and is excellent in heat resistance, can be provided.

### BRIEF DESCRIPTION OF DRAWINGS

FIG. 1 is a schematic sectional view of a stress relaxation tester.

### DESCRIPTION OF EMBODIMENTS

<<<<1. Resin Foam>>>>

A resin foam of the present invention has cell structures, wherein the resin foam has an apparent density of from 0.05 g/cm³ to 0.50 g/cm³, wherein the resin foam has a 50% compression load of from 2.0 N/cm² to 30 N/cm², and wherein the resin foam has an apparent density D (g/cm³) and a residue R (%) at 650° C. satisfying a relationship of the following expression (1).

1≤{(100−R)/D}/100≤10 (1)

As used herein, the residue R refers to a residue at 650° C. when the resin foam is increased in temperature under a nitrogen gas atmosphere within a measurement range of from 25° C. to 680° C. at a rate of temperature increase of 20° C/min. The residue R may be measured, for example, through use of “TG/DTA6200” (product name) manufactured by SII Nano Technology Inc.

When the resin foam of the present invention has the above-mentioned configuration, the resin foam has high stress dispersibility and heat resistance. In addition, the resin foam of the present invention is excellent also in flexibility. The resin foam of the present invention can exhibit excellent impact absorbability even in a portion in which a clearance is narrow partly because the resin foam has high stress dispersibility. In addition, the resin foam excellent in heat resistance may be suitably used as a protective member in a device that is liable to have a high temperature, such as a high-performance mobile device.

The apparent density of the resin foam of the present invention is preferably from 0.06 g/cm³ to 0.45 g/cm³, more preferably from 0.07 g/cm³ to 0.40 g/cm³, still more preferably from 0.08 g/cm³ to 0.35 g/cm³. When the apparent density falls within such ranges, a resin foam that is more excellent in stress dispersibility can be obtained. A method of measuring the apparent density is described later.

The 50% compression load of the resin foam of the present invention is preferably from 2.5 N/cm² to 25 N/cm², more preferably from 3.0 N/cm² to 20 N/cm², still more preferably from 3.5 N/cm² to 15 N/cm². When the 50% compression load falls within such ranges, a resin foam that is more excellent in stress dispersibility can be obtained. A method of measuring the 50% compression load of the resin foam is described later.

As described above, the apparent density D (g/cm³) and the residue R (%) at 650° C. satisfy a relationship of the following expression (1).

1≤{(100−R)/D}/100≤10 (1)

The apparent density D (g/cm³) and the residue R (%) at 650° C. preferably satisfy a relationship of the following expression (2). The apparent density D (g/cm³) and the residue R (%) at 650° C. more preferably satisfy a relationship of the following expression (3). The apparent density D (g/cm³) and the residue R (%) at 650° C. still more preferably satisfy a relationship of the following expression (4). When the apparent density D and the residue R have such relationship, a resin foam in which both of high stress dispersibility and heat resistance are achieved at a high level can be obtained.

2≤{(100−R)/D}/100≤9.5 (2)

3≤{(100−R)/D}/100≤8.5 (3)

3.5≤{(100−R)/D}/100≤8 (4)

The residue R at 650° C. of the resin foam of the present invention is preferably 10 wt % or more, more preferably wt % or more, still more preferably 20 wt % or more, particularly preferably 25 wt % or more, most preferably 35 wt % or more. When the residue R falls within such ranges, a resin foam that is particularly excellent in heat resistance can be obtained. The upper limit of the residue R is, for example, 80 wt %, and in one embodiment, 60 wt %. In one embodiment, the residue R may be an inorganic component (for example, an inorganic filler) contained in the resin foam.

The resin foam of the present invention has cell structures. Examples of such cell structure include a closed-cell structure, an open-cell structure, and a semi-open and semi-closed-cell structure (cell structure in which a closed-cell structure and an open-cell structure are mixed). The cell structure of the resin foam of the present invention is preferably an open-cell structure or a semi-open and semi-closed-cell structure, more preferably a semi-open and semi-closed-cell structure. When the cell structure of the resin foam of the present invention is a semi-open and semi-closed-cell structure, the ratio of a closed-cell structure therein is preferably 40% or less, more preferably 30% or less.

The closed-cell ratio of the resin foam of the present invention is obtained by, for example, submerging an object to be measured in water under an environment having a temperature of 23° C. and a humidity of 50%, measuring the mass of the object thereafter, then sufficiently drying the object in an oven at 80° C., and then measuring the mass of the resultant again. In addition, open cells can retain water, and hence the mass thereof can be measured to be obtained as open cells.

The cells have an average cell diameter of preferably from 10 μm to 200 μm, more preferably from 15 μm to 180 μm, still more preferably from 20 μm to 150 μm, particularly preferably from 23 μm to 120 μm, particularly preferably from 25 μm to 100 pm. When the average cell diameter falls within such ranges, a resin foam that is more excellent in flexibility and stress dispersibility can be obtained. In addition, a resin foam that is excellent also in compression recoverability and is excellent in durability against repeated impacts can be obtained. A method of measuring the average cell diameter is described later.

The cells have a coefficient of variation in cell diameter of preferably 0.5 or less, more preferably 0.48 or less, still more preferably 0.45 or less, particularly preferably 0.43 or less, most preferably less than 0.4. When the coefficient of variation falls within such ranges, the deformation caused by an impact becomes uniform, and local stress loading is prevented. As a result, a resin foam that is excellent in stress dispersibility and is particularly excellent in impact resistance can be obtained. The coefficient of variation is preferably smaller, but the lower limit thereof is, for example, 0.2 (preferably 0.15, more preferably 0.1, still more preferably 0.01). A method of measuring the coefficient of variation in cell diameter is described later.

The cell structure has a cell ratio of preferably 30% or more, more preferably 50% or more, still more preferably 80% or more. When the cell ratio falls within such ranges, a resin foam having a small repulsive stress at the time of compression can be obtained. Such resin foam can reduce the stress applied to other members when the resin foam is applied under the condition of being compressed to a certain degree to a portion having a narrow clearance. For example, when the resin foam is applied to a display member, the stress applied to the display member can be relaxed and dispersed, and hence the foregoing is useful from the viewpoints of reducing color unevenness and protecting the member. The upper limit of the cell ratio is, for example, 99% or less. A method of measuring the cell ratio is described later.

The thickness of a cell wall in the cell structure is preferably from 0.1 μm to 10 μm, more preferably from 0.3 μm to 8 μm, still more preferably from 0.5 μm to 5 μm, particularly preferably from 0.7 μm to 4 μm, most preferably from 1 μm to 3 μm. When the thickness of the cell wall falls within such ranges, a resin foam that is more excellent in flexibility and stress dispersibility can be obtained. When the thickness of the cell wall is too thin, the resin foam is easily deformed with respect to a load, and there is a risk in that a sufficient stress dispersion effect may not be obtained. When the thickness of the cell wall is too thick, the resin foam is not easily deformed with respect to a load, and there is a risk in that the step followability may be deteriorated when the resin foam is used in a gap of the device. The thickness of the cell wall may be measured by capturing an enlarged image of a cell portion of the resin foam and analyzing the image through use of analysis software of a measuring instrument.

The rupture elongation at 23° C. of the resin foam of the present invention is preferably 120% or less, more preferably 110% or less, still more preferably 105% or less, yet still more preferably 100% or less, particularly preferably 95% or less, most preferably 90% or less. When the rupture elongation falls within such ranges, a resin foam that is excellent in stress dispersibility and is excellent in impact absorbability even when the resin foam is thin can be obtained. In the case where the rupture elongation in a tensile test is small, when a load is applied to the resin foam, the deformation of the cell wall of the resin foam becomes small. For example, when a filler is added, slippage is liable to occur at an interface between the resin forming the resin foam and the filler, and the load can be further relaxed. The lower limit of the rupture elongation is preferably 1% or more, more preferably 5% or more, still more preferably 10% or more, particularly preferably 15% or more, most preferably 20% or more. Meanwhile, when the rupture elongation in a tensile test is too large, the deformation of the cell wall of the resin foam becomes large, and there is a risk in that the load may not be easily relaxed. The rupture elongation may be measured in accordance with JIS K 6767.

The dimensional change ratio when the resin foam is left under a 120° C. environment for 500 hours is preferably 1% or less, more preferably 0.8% or less. The dimensional change ratio is preferably smaller, but in actuality, the lower limit thereof is 0.1% (preferably 0.05%). A method of measuring the dimensional change ratio is described later.

The tensile modulus of elasticity at 23° C. of the resin foam is preferably 0.6 MPa or more, more preferably from 0.7 MPa to 5 MPa, still more preferably from 1 MPa to 4 MPa. When the tensile modulus of elasticity falls within such ranges, a resin foam that is excellent in stress dispersibility and can exhibit excellent impact absorbability even in the form of a thin film can be obtained. A method of measuring the tensile modulus of elasticity is described later.

The stress retentivity of the resin foam is preferably 60% or more, more preferably from 63% to 100%, still more preferably from 63% to 95%. When the stress retentivity falls within such ranges, a resin foam that is excellent in stress dispersibility and can exhibit impact absorbability even in the form of a thin film can be obtained. As used herein, the stress retentivity refers to a ratio between the tensile strength immediately after stretching the resin foam (10 mm (width)×100 mm (length)) at a rate of 300 m/min in a length direction by 20% and the tensile strength after retaining the stretched resin foam for 120 seconds (tensile strength after retention for 120 seconds/tensile strength immediately after stretching×100).

Any appropriate shape may be adopted as the shape of the resin foam of the present invention depending on purposes. Such shape is typically a sheet shape, and in this case, the resin foam of the present invention may be treated as a resin foam layer.

When the resin foam of the present invention has a sheet shape (that is, in the case of a resin foam layer), the thickness thereof is preferably from 30 μm to 5,000 μm, more preferably from 35 μm to 4,000 μm, still more preferably from 40 pm to 3,000 μm, particularly preferably from 45 μm to 2,500 μm. The resin foam of the present invention can exhibit excellent impact absorbability even when the resin foam is thin. Such resin foam may be suitably used as a protective material applied to a minute clearance.

The resin foam of the present invention may have a hot-melt layer on one surface or both surfaces thereof. The resin foam having the hot-melt layer may be obtained by, for example, rolling a resin foam (or a precursor of the resin foam) through use of a pair of heating rolls heated to a temperature equal to or higher than the melting temperature of a resin composition forming the resin foam.

The resin foam of the present invention may be formed by any appropriate method to the extent that the effects of the present invention are not impaired. A typical example of such method is a method involving foaming a resin composition containing a resin material (polymer).

<<1-1. Resin Composition>>

The resin foam of the present invention contains any appropriate resin. The resin foam may be typically obtained by foaming a composition containing a resin (resin composition).

Any appropriate resin may be used as the resin forming the resin foam (that is, the resin contained in the resin composition) to the extent that the effects of the present invention are not impaired. Examples of the resin include an acrylic resin, a silicone-based resin, a urethane-based resin, a polyolefin-based resin, an ester-based resin, and a rubber-based resin. The number of kinds of such resins may be only one, or two or more.

The content ratio of the resin is preferably from 30 parts by weight to 95 parts by weight, more preferably from 35 parts by weight to 90 parts by weight, still more preferably from 40 parts by weight to 80 parts by weight, particularly preferably from 40 parts by weight to 60 parts by weight with respect to 100 parts by weight of the resin foam.

In one embodiment, the resin foam includes a polyolefin-based resin. The number of kinds of the polyolefin-based resins may be only one, or two or more.

The content ratio of the polyolefin-based resin is preferably from 50 parts by weight to 100 parts by weight, more preferably from 70 parts by weight to 100 parts by weight, still more preferably from 90 parts by weight to 100 parts by weight, particularly preferably from 95 parts by weight to 100 parts by weight with respect to 100 parts by weight of the resin foam.

As the polyolefin-based resin, there is given preferably at least one kind selected from the group consisting of a polyolefin and a polyolefin-based elastomer, more preferably a form in which a polyolefin and a polyolefin-based elastomer are used in combination. The number of kinds of the polyolefins may be only one, or two or more. The number of kinds of the polyolefin-based elastomers may be only one, or two or more. As used herein, the term “polyolefin” does not encompass “polyolefin-based elastomer”.

When the polyolefin and the polyolefin-based elastomer are used in combination as the polyolefin-based resin, the content ratio of the polyolefin and the polyolefin-based elastomer (polyolefin/polyolefin-based elastomer) is preferably from 1/99 to 99/1, more preferably from 10/90 to 90/10, still more preferably from 20/80 to 80/20, particularly preferably from 30/70 to 70/30 in terms of weight ratio.

Any appropriate polyolefin may be adopted as the polyolefin to the extent that the effects of the present invention are not impaired. Examples of such polyolefin include a linear polyolefin and a branched polyolefin (having a branched chain).

Such polyolefin is, for example, a polymer containing an α-olefin, that is, a polymer having at least a structural unit derived from an α-olefin in one molecule. Such polyolefin may be a polymer containing only an α-olefin, or a polymer containing an α-olefin and a monomer component other than the α-olefin.

The polyolefin may be a homopolymer or a copolymer containing two or more kinds of monomers. When the polyolefin is a copolymer, any appropriate copolymerization form may be adopted as the copolymerization form thereof. Examples of such copolymerization form include a random copolymer and a block copolymer.

Preferred examples of the α-olefin, which may form the polyolefin, include α-olefins each having 2 to 8 carbon atoms (e.g., ethylene, propylene, 1-butene, 1-pentene, 1-hexene, 4-methyl-1-pentene, 1-heptene, and 1-octene). The number of kinds of the α-olefins, each of which may form the polyolefin, may be only one, or two or more.

Examples of the monomer component other than the α-olefin, which may form the polyolefin, include ethylenically unsaturated monomers, such as vinyl acetate, acrylic acid, an acrylic acid ester, methacrylic acid, a methacrylic acid ester, and vinyl alcohol. The number of kinds of the monomer components other than the α-olefin, each of which may form the polyolefin, may be only one, or two or more.

Specific examples of the polyolefin include low-density polyethylene, medium-density polyethylene, high-density polyethylene, linear low-density polyethylene, polypropylene (propylene homopolymer), a copolymer of ethylene and propylene, a copolymer of ethylene and an α-olefin other than ethylene, a copolymer of propylene and an α-olefin other than propylene, a copolymer of ethylene, propylene, and an α-olefin other than ethylene and propylene, and a copolymer of propylene and an ethylenically unsaturated monomer.

The polyolefin is preferably a polymer containing propylene as an essential monomer component (polypropylene-based polymer), that is, a polymer having at least a structural unit derived from propylene from the viewpoint that the effects of the present invention can be further exhibited. Examples of such polypropylene-based polymer include polypropylene (propylene homopolymer), a copolymer of ethylene and propylene, and a copolymer of propylene and an α-olefin other than propylene, and the polypropylene-based polymer is preferably polypropylene (propylene homopolymer). The number of kinds of the polypropylene-based polymers may be only one, or two or more.

The melt flow rate (MFR) of the polyolefin at a temperature of 230° C. is preferably from 0.2 g/10 min to 10 g/10 min, more preferably from 0.25 g/10 min to 5 g/10 min, still more preferably from 0.3 g/10 min to 3 g/10 min, particularly preferably from 0.35 g/10 min to 1.5 g/10 min from the viewpoint that the effects of the present invention can be further exhibited. The melt flow rate (MFR) of the polyolefin at a temperature of 230° C. refers to an MFR measured at a temperature of 230° C. and a load of 2.16 kgf based on ISO 1133 (JIS-K-7210).

Two or more kinds of polyolefins having different melt flow rates (MFRs) at a temperature of 230° C. within the above-mentioned ranges are preferably used in combination as the polyolefin from the viewpoint that the effects of the present invention can be further exhibited. In this case, a polyolefin having a melt flow rate (MFR) at a temperature of 230° C. of preferably 0.2 g/10 min or more and less than 0.7 g/10 min (more preferably from 0.2 g/10 min to 0.65 g/10 min) is used in combination with a polyolefin having a melt flow rate (MFR) at a temperature of 230° C. of preferably from 0.7 g/10 min to 10 g/10 min (more preferably from 0.7 g/10 min to 5 g/10 min, still more preferably from 0.7 g/10 min to 3 g/10 min, particularly preferably from 0.7 g/10 min to 1.5 g/10 min, most preferably from 0.7 g/10 min to 1.3 g/10 min).

When the two or more kinds of polyolefins having different melt flow rates (MFRs) at a temperature of 230° C. within the above-mentioned ranges are used in combination as the polyolefin, for example, a content ratio between such a polyolefin that the above-mentioned melt flow rate (MFR) at a temperature of 230° C. is preferably 0.2 g/10 min or more and less than 0.7 g/10 min (more preferably from 0.2 g/10 min to 0.65 g/10 min) and such a polyolefin that the melt flow rate (MFR) at a temperature of 230° C. is preferably from 0.7 g/10 min to 10 g/10 min (more preferably from 0.7 g/10 min to 5 g/10 min, still more preferably from 0.7 g/10 min to 3 g/10 min, particularly preferably from 0.7 g/10 min to 1.5 g/10 min, most preferably from 0.7 g/10 min to 1.3 g/10 min) is preferably from 1/99 to 99/1, more preferably from 10/90 to 90/10, still more preferably from 20/80 to 80/20, particularly preferably from 30/70 to 70/30, most preferably from 40/60 to 60/40 in terms of weight ratio from the viewpoint that the effects of the present invention can be further exhibited.

A commercially available product may be used as the polyolefin. Examples thereof include “E110G” (manufactured by Prime Polymer Co., Ltd.), “EA9” (manufactured by Japan Polypropylene Corporation), “EA9FT” (manufactured by Japan Polypropylene Corporation), “E-185G” (manufactured by Prime Polymer Co., Ltd.), “WB140HMS” (manufactured by Borealis AG), and “WB135HMS” (manufactured by Borealis AG).

Any appropriate polyolefin-based elastomer may be adopted as the polyolefin-based elastomer to the extent that the effects of the present invention are not impaired. Examples of such polyolefin-based elastomer include: an ethylene-propylene copolymer, an ethylene-propylene-diene copolymer, an ethylene-vinyl acetate copolymer, polybutene, polyisobutylene, chlorinated polyethylene, and a so-called non-cross-linked thermoplastic olefin-based elastomer (TPO), such as an elastomer in which a polyolefin component and a rubber component are physically dispersed, or an elastomer having a structure in which a polyolefin component and a rubber component are microphase-separated; and a dynamically cross-linked thermoplastic olefin-based elastomer (TPV) that is a multiphase polymer which is obtained by dynamically heat-treating a mixture containing a resin component A (olefin-based resin component A) forming a matrix and a rubber component B forming a domain in the presence of a cross-liking agent, and which has a sea-island structure in which cross-linked rubber particles are finely dispersed as a domain (island phase) in the resin component A that is a matrix (sea phase).

The polyolefin-based elastomer preferably contains a rubber component. Examples of such rubber component include those described in JP 08-302111 A, JP 2010-241934 A, JP 2008-024882 A, JP 2000-007858 A, JP 2006-052277 A, JP 2012-072306 A, JP 2012-057068 A, JP 2010-241897 A, JP 2009-067969 A, and JP 03/002654 Al.

Specific examples of the elastomer having a structure in which a polyolefin component and an olefin-based rubber component are microphase-separated include an elastomer formed of a polypropylene resin (PP) and an ethylene-propylene rubber (EPM) and an elastomer formed of a polypropylene resin (PP) and an ethylene-propylene-diene rubber (EPDM). The weight ratio between the polyolefin component and the olefin-based rubber component as the polyolefin component/olefin-based rubber is preferably from 90/10 to 10/90, more preferably from 80/20 to 20/80 from the viewpoint of compatibility.

The dynamically cross-linked thermoplastic olefin-based elastomer (TPV) generally has a higher modulus of elasticity and a smaller compression set as compared to the non-cross-linked thermoplastic olefin-based elastomer (TPO). As a result, the dynamically cross-linked thermoplastic olefin-based elastomer (TPV) has satisfactory recoverability, and can exhibit excellent recoverability when formed into a foam.

As described above, the dynamically cross-linked thermoplastic olefin-based elastomer (TPV) is a multiphase polymer which is obtained by dynamically heat-treating a mixture containing a resin component A (olefin-based resin component A) forming a matrix and a rubber component B forming a domain in the presence of a cross-liking agent, and which has a sea-island structure in which cross-linked rubber particles are finely dispersed as a domain (island phase) in the resin component A that is a matrix (sea phase).

Examples of the dynamically cross-linked thermoplastic olefin-based elastomer (TPV) include those described in JP 2000-007858 A, JP 2006-052277 A, JP 2012-072306 A, JP 2012-057068 A, JP 2010-241897 A, JP 2009-067969 A, and JP 03/002654 A1.

A commercially available product may be used as the dynamically cross-linked thermoplastic olefin-based elastomer (TPV). Examples thereof include “Zeotherm” (manufactured by Zeon Corporation), “THERMORUN” (manufactured by Mitsubishi Chemical Corporation), and “SARLINK 3245D” (manufactured by Toyobo Co., Ltd.).

The melt flow rate (MFR) of the polyolefin-based elastomer at a temperature of 230° C. is preferably from 2 g/10 min to 15 g/10 min, more preferably from 3 g/10 min to 10 g/10 min, still more preferably from 3.5 g/10 min to 9 g/10 min, particularly preferably from 4 g/10 min to 8 g/10 min, most preferably from 4.5 g/10 min to 7.5 g/10 min. The melt flow rate (MFR) of the polyolefin-based elastomer at a temperature of 230° C. refers to an MFR measured at a temperature of 230° C. and a load of 2.16 kgf based on ISO 1133 (JIS-K-7210).

The melt tension (190° C., at the time of rupture) of the polyolefin-based elastomer is preferably less than 10 cN, more preferably from 5 cN to 9.5 cN.

The JIS A hardness of the polyolefin-based elastomer is preferably from 30° to 95°, more preferably from 35° to 90°, still more preferably from 40° to 88°, particularly preferably from 45° to 85°, most preferably from 50° to 83°. The JIS A hardness refers to hardness measured based on ISO 7619 (JIS K 6253).

In one embodiment, the resin foam (that is, the resin composition) may further contain a filler. When the filler is contained, a resin foam that requires large energy for deforming a cell wall can be formed, and the resin foam exhibits excellent impact absorbability. In addition, when the filler is contained, a fine and uniform cell structure can be formed, and the foregoing is advantageous also from the viewpoint of exhibiting excellent impact absorbability. The fillers may be used alone or in combination thereof.

The content ratio of the filler is preferably from 10 parts by weight to 150 parts by weight, more preferably from 30 parts by weight to 130 parts by weight, still more preferably from 50 parts by weight to 100 parts by weight with respect to 100 parts by weight of the polymer forming the resin foam. When the content ratio of the filler falls within such ranges, the above-mentioned effects become outstanding.

In one embodiment, the filler is an inorganic material. Examples of a material forming the filler which is an inorganic material include aluminum hydroxide, magnesium hydroxide, calcium carbonate, magnesium carbonate, calcium silicate, magnesium silicate, calcium oxide, magnesium oxide, aluminum oxide, aluminum nitride, aluminum borate whisker, silicon nitride, boron nitride, crystalline silica, amorphous silica, a metal (e.g., gold, silver, copper, aluminum, or nickel), carbon, and graphite.

In one embodiment, the filler is an organic material. Examples of a material forming the filler which is an organic material include polymethyl methacrylate (PMMA), polyimide, polyamideimide, polyether ether ketone, polyetherimide, and polyesterimide.

A flame retardant may be used as the filler. Examples of the flame retardant include a bromine-based flame retardant, a chlorine-based flame retardant, a phosphorus-based flame retardant, and an antimony-based flame retardant. Preferably, a non-halogen-non-antimony-based flame retardant is used from the viewpoint of safety.

The non-halogen-non-antimony-based flame retardant is, for example, a compound containing aluminum, magnesium, calcium, nickel, cobalt, tin, zinc, copper, iron, titanium, boron, or the like. Examples of such compound (inorganic compound) include hydrated metal compounds, such as aluminum hydroxide, magnesium hydroxide, a magnesium oxide/nickel oxide hydrate, and a magnesium oxide/zinc oxide hydrate.

The filler may be subjected to any appropriate surface treatment. Examples of the surface treatment include silane coupling treatment and stearic acid treatment.

The bulk density of the filler is preferably 0.8 g/cm³ or less, more preferably 0.6 g/cm³ or less, still more preferably 0.4 g/cm³ or less, particularly preferably 0.3 g/cm³ or less. When the bulk density of the filler falls within such ranges, the filler can be contained with satisfactory dispersibility, and the filler addition effect can be sufficiently exhibited even when the content of the filler is reduced. The resin foam having a small content of the filler is advantageous from the viewpoint of being excellent in high foam expansion rate, flexibility, stress dispersibility, and external appearance. The lower limit value of the bulk density of the filler is, for example, 0.01 g/cm³, preferably 0.05 g/cm³, more preferably 0.1 g/cm³.

The number average particle diameter (primary particle diameter) of the filler is preferably 5 μm or less, more preferably 3 μm or less, still more preferably 1 μm or less. When the number average particle diameter of the filler falls within such ranges, the filler can be contained with satisfactory dispersibility, and a uniform cell structure can be formed. As a result, a resin foam that is excellent in stress dispersibility and external appearance can be obtained. The lower limit value of the number average particle diameter of the filler is, for example, 0.1 μm. The number average particle diameter of the filler may be measured with a particle size distribution analyzer (Microtrac II, manufactured by MicrotracBEL Corp.) through use of, as a sample, a suspension prepared by mixing 1 g of a filler with 100 g of water.

The specific surface area of the filler is preferably 2 m²/g or more, more preferably 4 m²/g or more, still more preferably 6 m²/g or more. When the specific surface area of the filler falls within such ranges, the filler can be contained with satisfactory dispersibility, and a uniform cell structure can be formed. As a result, a resin foam that is excellent in stress dispersibility and external appearance can be obtained. The upper limit value of the specific surface area of the filler is, for example, 20 m²/g. The specific surface area of the filler may be measured by a BET method, that is, based on an adsorption amount obtained by adsorbing molecules each having a known adsorption occupying area to the surface of the filler at low temperature with liquid nitrogen.

The resin composition may contain any appropriate other components to the extent that the effects of the present invention are not impaired. The number of kinds of such other components may be only one, or two or more. Examples of such other component include a rubber, a resin other than the polymer blended as the resin material, a softening agent, an aliphatic compound, an age resistor, an antioxidant, a light stabilizer, a weathering agent, a UV absorber, a dispersant, a plasticizer, carbon, an antistatic agent, a surfactant, a cross-linking agent, a thickener, a rust preventive, a silicone-based compound, a tension modifier, an anti-shrinkage agent, a fluidity modifier, a gelling agent, a curing agent, a reinforcing agent, a foaming agent, a foam nucleating agent, a colorant (e.g., a pigment or a dye), a pH adjustor, a solvent (organic solvent), a thermal polymerization initiator, a photopolymerization initiator, a lubricant, a crystal nucleating agent, a crystallization accelerator, a vulcanizing agent, a surface treatment agent, and a dispersing aid.

<<1-2. Formation of Resin Foam>>

The resin foam of the present invention is typically obtained by foaming a resin composition. A method to be generally used for foam forming, such as a physical method or a chemical method, may be adopted as a foaming method (method of forming cells). That is, the resin foam of the present invention may be typically a foam formed through foaming by a physical method (physical foam), or may be a foam formed through foaming by a chemical method (chemical foam). The physical method generally involves dispersing a gas component, such as air or nitrogen, in a polymer solution, and forming cells through mechanical mixing (mechanical foam). The chemical method is generally a method involving forming cells with a gas produced by the thermal decomposition of a foaming agent added to a polymer base, to thereby obtain a foam.

The resin composition may be prepared by mixing constituent components through use of any appropriate means, for example, any appropriate melt-kneading apparatus, such as an open-type mixing roll, a closed-type Banbury mixer, a single-screw extruder, a twin-screw extruder, a continuous kneader, or a pressurizing kneader.

### First Embodiment for Forming Resin Foam of the Present Invention

As a first embodiment for forming the resin foam of the present invention, there is given, for example, a mode of forming a resin foam through a step of mechanically foaming an emulsion resin composition (emulsion containing the resin material and the like) to produce cells (step A). As a foaming apparatus, there are given, for example, an apparatus of a high-speed shearing system, an apparatus of a vibration system, and an apparatus of a pressurized gas-ejecting system. Of those foaming apparatus, an apparatus of a high-speed shearing system is preferred from the viewpoints of a reduction in cell diameter and large-volume production. The first embodiment for forming the resin foam of the present invention is applicable to formation from any resin composition.

The solid content concentration of the emulsion is preferably as high as possible from the viewpoint of film formability. The solid content concentration of the emulsion is preferably 30 wt % or more, more preferably 40 wt % or more, still more preferably 50 wt % or more.

A cell when the resin composition is foamed by mechanical stirring is such that a gas is taken in an emulsion. Any appropriate gas may be adopted as the gas as long as the gas is inert to the emulsion to the extent that the effects of the present invention are not impaired. Examples of such gas include air, nitrogen, and carbon dioxide.

The resin foam of the present invention may be obtained through a step of applying the emulsion resin composition (bubble-containing emulsion resin composition) foamed by the above-mentioned method onto a base material, followed by drying (step B). Examples of the base material include a release-treated plastic film (e.g., a release-treated polyethylene terephthalate film) and a plastic film (e.g., a polyethylene terephthalate film).

Any appropriate methods may be adopted as an application method and a drying method in the step B to the extent that the effects of the present invention are not impaired. The step B preferably includes: a preliminary drying step B1 of drying the bubble-containing emulsion resin composition applied onto the base material at 50° C. or more and less than 125° C.; and a main drying step B2 of further drying the composition at 125° C. or more and 200° C. or less after the preliminary drying.

The provision of the preliminary drying step B1 and the main drying step B2 can prevent the coalescence of cells and the rupture of the cells due to an abrupt temperature increase. Particularly in a foam sheet having a small thickness, the significance of the provision of the preliminary drying step B1 is large because the cells coalesce or rupture owing to an abrupt temperature increase. The temperature in the preliminary drying step B1 is preferably from 50° C. to 100° C. A time period for the preliminary drying step B1 is preferably from 0.5 minute to 30 minutes, more preferably from 1 minute to 15 minutes. The temperature in the main drying step B2 is preferably from 130° C. to 180° C. or less, more preferably from 130° C. to 160° C. A time period for the main drying step B2 is preferably from 0.5 minute to 30 minutes, more preferably from 1 minute to 15 minutes.

### Second Embodiment for Forming Resin Foam of the Present Invention

As a second embodiment for forming the resin foam of the present invention, there is given a mode of forming a foam by foaming a resin composition with a foaming agent. A foaming agent to be generally used for foam forming may be used as the foaming agent, and a high-pressure inert gas is preferably used from the viewpoints of environmental protection and a low property of contaminating the object to be foamed.

Any appropriate inert gas may be adopted as the inert gas as long as the gas is inert to, and can impregnate, the resin composition. Examples of such inert gas include carbon dioxide, a nitrogen gas, and air. Those gases may be used as a mixture. Of those, carbon dioxide is preferred from the viewpoint of impregnating the resin material (polymer) with a large amount and at a high rate.

The inert gas is preferably in a supercritical state. That is, carbon dioxide in a supercritical state is particularly preferably used. In the supercritical state, the solubility of the inert gas into the resin composition further increases. Consequently, the inert gas can be mixed at a high concentration into the composition, and besides, the inert gas has a high concentration at the time of an abrupt pressure reduction. Accordingly, the frequency of occurrence of cell nuclei increases, and the density of cells to be produced by the growth of the cell nuclei becomes larger than in any other state even with the same porosity. Thus, fine cells can be obtained. Carbon dioxide has a critical temperature of 31° C. and a critical pressure of 7.4 MPa.

As a method of forming a foam by impregnating the resin composition with the high-pressure inert gas, there is given, for example, a method of forming a foam through: a gas-impregnating step of impregnating the resin composition with the inert gas under high pressure; a decompressing step of reducing the pressure after the gas-impregnating step to foam the resin; and as required, a heating step of growing cells by heating. In this case, an unfoamed formed body that has been formed in advance may be impregnated with the inert gas, or a resin composition that has been melted may be impregnated with the inert gas under a pressurized state and then subjected to forming at the time of the decompression. Those steps may be performed by any of a batch system and a continuous system. That is, the steps may be performed by a batch system involving forming the resin composition into an appropriate shape, such as a sheet shape, to provide an unfoamed resin formed body in advance, then impregnating the unfoamed resin formed body with the high-pressure gas, and releasing the pressure of the gas to foam the formed body, or may be performed by a continuous system involving kneading the resin composition together with the high-pressure gas under increased pressure, and forming the kneaded product, and at the same time, releasing the pressure to simultaneously perform the forming and foaming of the kneaded product.

An example in which the foam is produced by the batch system is described below. For example, the resin composition is extruded with an extruder, such as a single-screw extruder or a twin-screw extruder, to thereby produce a resin sheet for foam forming. Alternatively, the resin composition is uniformly kneaded with a kneader including a blade of, for example, a roller-, cam-, kneader-, or Banbury-type, and the kneaded product is subjected to press processing into a predetermined thickness with, for example, a hot-plate press, to thereby produce an unfoamed resin formed body. The thus obtained unfoamed resin formed body is placed in a pressure vessel, and the high-pressure inert gas (e.g., carbon dioxide in a supercritical state) is injected to impregnate the unfoamed resin formed body with the inert gas. At the time point when the unfoamed resin formed body is sufficiently impregnated with the inert gas, the pressure is released (to typically atmospheric pressure) to produce cell nuclei in the resin. The cell nuclei may be directly grown at room temperature, but may be grown by being heated in some cases. A known or commonly used method, such as a water bath, an oil bath, a heat roll, a hot-air oven, a far-infrared ray, a near-infrared ray, or a microwave, may be adopted as a method for the heating. After cells have been thus grown, their shapes are fixed by abrupt cooling with, for example, cold water. Thus, the foam may be obtained. The unfoamed resin formed body to be subjected to foaming is not limited to a sheet-shaped product, and unfoamed resin formed bodies having various shapes may be used depending on applications. In addition, the unfoamed resin formed body to be subjected to foaming may be produced by any other forming method, such as injection molding, as well as extrusion molding or press forming.

An example in which the foam is produced by the continuous system is described below. For example, foam forming is performed by: a kneading and impregnating step of injecting (introducing) a high-pressure gas (in particular, an inert gas, more preferably carbon dioxide) while kneading the resin composition with an extruder, such as a single-screw extruder or a twin-screw extruder, to sufficiently impregnate the resin composition with the high-pressure gas; and a forming and decompressing step of extruding the resin composition through a die or the like arranged at the tip of the extruder to release the pressure (to typically atmospheric pressure), thereby simultaneously performing the forming and foaming of the composition. In addition, in the foam forming by the continuous system, a heating step of growing cells by heating may be provided as required. After the cells have been thus grown, their shapes may be fixed by abrupt cooling with, for example, cold water as required. In addition, the introduction of the high-pressure gas may be continuously performed, or may be discontinuously performed. Further, in the kneading and impregnating step and the forming and decompressing step, for example, an extruder or an injection molding machine may be used. A heating method at the time of the growth of cell nuclei is, for example, any appropriate method, such as a water bath, an oil bath, a heat roll, a hot-air oven, a far-infrared ray, a near-infrared ray, or a microwave. Any appropriate shape may be adopted as the shape of the foam. Examples of such shape include a sheet shape, a prism shape, a cylindrical shape, and a heteromorphic shape.

The mixing amount of the gas at the time of the foam forming of the resin composition is, for example, preferably from 2 parts by weight to 10 parts by weight, more preferably from 2.5 parts by weight to 8 parts by weight, still more preferably from 3 parts by weight to 6 parts by weight with respect to 100 parts by weight of the resin composition because a highly foamed foam can be obtained.

The pressure at the time of the impregnation of the resin composition with the inert gas may be appropriately selected in consideration of operability or the like. Such pressure is, for example, preferably 6 MPa or more (e.g., from 6 MPa to 100 MPa), more preferably 8 MPa or more (e.g., from 8 MPa to 50 MPa). The pressure in the case of using carbon dioxide in a supercritical state is preferably 7.4 MPa or more from the viewpoint of retaining the supercritical state of carbon dioxide. When the pressure is less than 6 MPa, cell growth at the time of the foaming is remarkable, and hence the cell diameter becomes so large that a preferred average cell diameter cannot be obtained in some cases. This is because of the following reason. When the pressure is low, the impregnation amount of the gas becomes relatively small as compared to that at the time of high pressure, and hence a cell nucleus formation rate is reduced to decrease the number of cell nuclei to be formed. Accordingly, the amount of the gas per one cell is inversely increased, and hence the cell diameter becomes excessively large. In addition, in a pressure region of less than 6 MPa, even when the impregnation pressure is changed to a small extent, the cell diameter and a cell density are changed to a large extent, and hence the cell diameter and the cell density are liable to become difficult to control.

The temperature in the gas-impregnating step varies depending on, for example, the kinds of the inert gas to be used and components in the resin composition, and may be selected from a wide range. When operability or the like is taken into consideration, the temperature is preferably from 10° C. to 350° C. The impregnation temperature in the case of impregnating the unfoamed formed body with the inert gas by the batch system is preferably from 10° C. to 250° C., more preferably from 40° C. to 230° C. In addition, the impregnation temperature in the case of extruding a molten polymer impregnated with the gas to simultaneously perform the foaming and forming of the polymer by the continuous system is preferably from 60° C. to 350° C. When carbon dioxide is used as the inert gas, the temperature at the time of the impregnation is preferably 32° C. or more, more preferably 40° C. or more in order to retain the supercritical state of the gas.

In the decompressing step, a decompression rate is preferably from 5 MPa/sec to 300 MPa/sec in order to obtain uniform and fine cells.

A heating temperature in the heating step is preferably from 40° C. to 250° C., more preferably from 60° C. to 250° C.

<<<<2. Foam Member>>>>

A foam member of the present invention includes: the resin foam layer formed of the resin foam; and a pressure-sensitive adhesive layer arranged on at least one side of the resin foam layer.

The thickness of the resin foam layer included in the foam member of the present invention is preferably from 30 pm to 5,000 μm, more preferably from 35 μm to 4,000 μm, still more preferably from 40 μm to 3,000 μm, particularly preferably from 45 μm to 2,500 μm. When the thickness of the resin foam layer falls within the above-mentioned ranges, the resin foam layer can easily follow even a minute clearance. In addition, when the thickness of the resin foam layer falls within the above-mentioned ranges, the resin foam layer can contain cells in a uniform manner, and can exhibit excellent impact absorbability.

The thickness of the pressure-sensitive adhesive layer is preferably from 5 μm to 300 μm, more preferably from 6 μm to 200 μm, still more preferably from 7 μm to 100 μm, particularly preferably from 8 μm to 50 μm. When the thickness of the pressure-sensitive adhesive layer falls within the above-mentioned ranges, the foam member of the present invention can exhibit excellent impact absorbability.

A layer formed of any appropriate pressure-sensitive adhesive may be adopted as the pressure-sensitive adhesive layer. Examples of the pressure-sensitive adhesive forming the pressure-sensitive adhesive layer include a rubber-based pressure-sensitive adhesive (e.g., a synthetic rubber-based pressure-sensitive adhesive or a natural rubber-based pressure-sensitive adhesive), a urethane-based pressure-sensitive adhesive, an acrylic urethane-based pressure-sensitive adhesive, an acrylic pressure-sensitive adhesive, a silicone-based pressure-sensitive adhesive, a polyester-based pressure-sensitive adhesive, a polyamide-based pressure-sensitive adhesive, an epoxy-based pressure-sensitive adhesive, a vinyl alkyl ether-based pressure-sensitive adhesive, a fluorine-based pressure-sensitive adhesive, and a rubber-based pressure-sensitive adhesive. The pressure-sensitive adhesive forming the pressure-sensitive adhesive layer is preferably at least one kind selected from an acrylic pressure-sensitive adhesive, a silicone-based pressure-sensitive adhesive, and a rubber-based pressure-sensitive adhesive. The number of kinds of such pressure-sensitive adhesives may be only one, or two or more. The number of the pressure-sensitive adhesive layers may be one, or two or more.

When the pressure-sensitive adhesives are classified in terms of pressure-sensitive adhesive form, examples thereof include an emulsion-type pressure-sensitive adhesive, a solvent-type pressure-sensitive adhesive, an ultraviolet cross-linking-type (UV cross-linking-type) pressure-sensitive adhesive, an electron beam cross-linking-type (EB cross-linking-type) pressure-sensitive adhesive, and a hot melt-type pressure-sensitive adhesive. The number of kinds of such pressure-sensitive adhesives may be only one, or two or more.

The water vapor transmission rate of the pressure-sensitive adhesive layer is preferably 50 (g/(m²·24 hours)) or less, more preferably 30 (g/(m²·24 hours)) or less, still more preferably 20 (g/(m²·24 hours)) or less, particularly preferably 10 (g/(m²·24 hours)) or less. When the water vapor transmission rate of the pressure-sensitive adhesive layer falls within the above-mentioned ranges, the impact absorbability of the foam sheet of the present invention can be stabilized without being influenced by water.

The pressure-sensitive adhesive forming the pressure-sensitive adhesive layer may contain any appropriate other components to the extent that the effects of the present invention are not impaired.

Examples of the other component include any other polymer component, a softening agent, an age resistor, a curing agent, a plasticizer, a filler, an antioxidant, a thermal polymerization initiator, a photopolymerization initiator, a UV absorber, a light stabilizer, a colorant (e.g., a pigment or a dye), a solvent (organic solvent), a surfactant (e.g., an ionic surfactant, a silicone-based surfactant, or a fluorine-based surfactant), and a cross-linking agent (e.g., a polyisocyanate-based cross-linking agent, a silicone-based crosslinking agent, an epoxy-based cross-linking agent, or an alkyl etherified melamine-based cross-linking agent). The thermal polymerization initiator and the photopolymerization initiator may be contained in the material for forming the polymer component.

The foam member of the present invention may be produced by any appropriate method. The foam member of the present invention may be produced by, for example, a method involving laminating the resin foam layer and the pressure-sensitive adhesive layer, or a method involving laminating a material for forming the pressure-sensitive adhesive layer and the resin foam layer, and then forming the pressure-sensitive adhesive layer through a curing reaction or the like.

### EXAMPLES

Now, the present invention is described specifically by way of Examples. However, the present invention is by no means limited to these Examples. Test and evaluation methods in Examples and the like are as described below. The term “part(s)” in the following description means “part(s) by weight” unless otherwise specified, and the term “%” in the following description means “wt %” unless otherwise specified.

<Method of Measuring Apparent Density>

The density (apparent density) of the resin foam was calculated as described below. A resin foam structure obtained in each of Examples and Comparative Examples was punched into a size of 20 mm×20 mm to form a test piece, and the dimensions of the test piece were measured with a caliper. Next, the weight of the test piece was measured with an electronic balance. Then, the apparent density was calculated by the following expression.

Apparent density (g/cm³)=weight of test piece/volume of test piece

<Method of Measuring 50% Compression Load>

The measurement was performed in accordance with a method of measuring compression hardness of a foam described in JIS K 6767. Specifically, a stress (N) when the resin foam structure obtained in each of Examples and Comparative Examples was cut out into a size of 30 mm×30 mm to form a test piece and the test piece was compressed at a compression speed of 10 mm/min until a compression ratio of 50% was achieved was converted per unit area (1 cm²) to provide a 50% compression load (N/cm²).

<Methods of Measuring Average Cell Diameter and Coefficient of Variation in Cell Diameter>

An enlarged image of a cell portion of the resin foam structure obtained in each of Examples and Comparative Examples was captured through use of a digital microscope (product name: “VHX-500”, manufactured by Keyence Corporation) as a measuring instrument, and the image was analyzed through use of analysis software of the measuring instrument, to thereby obtain an average cell diameter (pm). The number of cells in the captured enlarged image was about 400. In addition, the standard deviation was calculated from all the cell diameter data, and the coefficient of variation was calculated through use of the following expression.

Coefficient of variation=standard deviation/average cell diameter

<Method of Measuring Cell Ratio>

The measurement was performed under an environment having a temperature of 23° C. and a humidity of 50%. The resin foam structure obtained in each of Examples and Comparative Examples was punched with a punching blade die measuring 100 mm by 100 mm, and the dimensions of the punched sample were measured. In addition, the thickness of the sample was measured with a 1/100 dial gauge having a measuring terminal with a diameter ((p) of 20 mm. The volume of the resin foam structure obtained in each of Examples and Comparative Examples was calculated from those values. Next, the weight of the resin foam structure obtained in each of Examples and Comparative Examples was measured with an even balance having a minimum scale of 0.01 g or more. The cell ratio of the resin foam structure obtained in each of Examples and Comparative Examples was calculated from those values.

<Method of Measuring Residue of Resin Foam at 650° C.>

5 mg of the resin foam structure obtained in each of Examples and Comparative Examples was placed in a platinum container, and the temperature was raised under a nitrogen gas atmosphere within a measurement range of from 25° C. to 680° C. at a rate of temperature increase of 20° C./min. The residue at 650° C. was measured through use of TG/DTA6200 (manufactured by SII Nano Technology Inc.).

<Method of Measuring Tensile Modulus of Elasticity of Resin Foam>

The tensile elongation (%) and tensile strength of a foam were measured based on the tensile elongation section of JIS K 6767, and the ratio of a change in tensile strength in a region having a tensile elongation of from 0% to 10% was calculated as a tensile modulus of elasticity in a graph in which tensile elongation was on the X-axis and the tensile strength was on the Y-axis.

<Method of Measuring Stress Retentivity of Resin Foam>

A ratio between the tensile strength immediately after stretching a resin foam (10 mm (width)×100 mm (length)) at a rate of 300 m/min in a length direction by 20% and the tensile strength after retaining the stretched resin foam for 120 seconds (tensile strength after retention for 120 seconds/tensile strength immediately after stretching×100) was obtained, and the ratio was defined as the stress retentivity of the resin foam.

<Method of Measuring Degree of Stress Dispersion (Stress Dispersibility)>

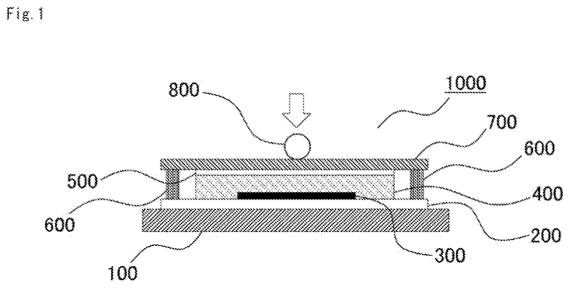

FIG. 1 is a schematic sectional view of a stress relaxation tester 1000 to be used for measuring a degree of stress dispersion.

As illustrated in FIG. 1, a polycarbonate plate (200 mm×300 mm×1 mm (thickness)) 200 was placed on an iron support 100, and a stress measurement film 300 (product name: “Prescale” (two sheets for extreme low pressure (4LW)), manufactured by Fujifilm Corporation, sheet having a surface on which a pressurized portion develops color, 50 mm×50 mm×0.16 mm (thickness)) was placed on the polycarbonate plate 200. Next, the resin foam structure (150 mm×200 mm×0.5 mm (thickness)) 400 obtained in each of Examples and Comparative Examples to be measured was placed on the stress measurement film 300, and a double-sided adhesive tape (No. 5603, manufactured by Nitto Denko Corporation, thickness: 0.03 mm) 500 was bonded to the resin foam structure 400. Then, a spacer 600 having a thickness of 0.3 mm was arranged, and an ABS plate (200 mm×300 mm×3 mm (thickness)) 700 was placed in an uppermost portion. An iron ball (φ25 mm) 800 was placed in a center portion from above the ABS plate 700, to thereby apply a load of 100 N for 1 min.

After that, a change in color of the stress measurement film 300 was observed. The case in which the color did not spread from the center of the stress measurement film 300 and became a dot shape was evaluated as C. The case in which the color spread from the center of the stress measurement film 300 to 25 mm was evaluated as B. The case in which the color spread widely from the center of the stress measurement film 300 to an end portion of 50 mm was evaluated as A.

<Method of Measuring Dimensional Change Ratio>

The dimensional change ratio of the resin foam was measured by the B method in JIS K 6767:1999K “Cellular plastics-Polyethylene-Methods of test.”

The size of a test piece was set to 150 mm×150 mm. In a center portion of the test piece, three straight lines parallel to each other were drawn at intervals of 50 mm in each of vertical and horizontal directions. Then, the test piece was loaded into a hot air circulation-type dryer at 120° C. and left for 500 hours. Then, the test piece was taken out and left at normal temperature for 1 hour, and then the lengths of the drawn lines were measured. From an average length L0 (mm) of the drawn lines before heating and an average length L1 (mm) of the drawn lines after heating, a dimensional change ratio was determined by the following expression: |(L1−L0)|/L0×100.

### Example 1

50 Parts by weight of polypropylene [melt flow rate (MFR) (230° C.): 0.40 g/10 min], 25 parts by weight of polypropylene [melt flow rate (MFR) (230° C.): 2.40 g/10 min], 25 parts by weight of a polyolefin-based elastomer [melt flow rate (MFR): 6 g/10 min, JIS A hardness: 79°], 100 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3.5 parts by weight with respect to 100 parts by weight of the resin. After the carbon dioxide gas was sufficiently saturated, the resultant was cooled to a temperature suitable for foaming and then extruded from a die to provide a sheet-shaped resin foam A having a thickness of 1.8 mm.

In this foam, the apparent density was 0.085 g/cm³, the residue at 650° C. was 36%, the tensile modulus of elasticity was 1.6 MPa, and the stress retention ratio was 70%. The evaluation results of the resin foam A including those results are shown in Table 1.

### Example 2

The resin foam A was obtained in the same manner as in Example 1. The resin foam A was allowed to pass through between a pair of rolls (gap between the rolls) one of which was heated to 200° C., to thereby provide a resin foam B having a thickness of 0.15 mm. The gap between the rolls was set so that the resin foam B having a thickness of 0.15 mm was obtained.

In this foam, the apparent density was 0.18 g/cm³, the residue at 650° C. was 36%, the tensile modulus of elasticity was 2.1 MPa, and the stress retention ratio was 66%. The evaluation results of the resin foam B including those results are shown in Table 1.

### Example 3

19 Parts by weight of polypropylene [melt flow rate (MFR) (230° C.): 0.40 g/10 min], 19 parts by weight of polypropylene [melt flow rate (MFR) (230° C.): 1.1 g/10 min], 67 parts by weight of a polyolefin-based elastomer [melt flow rate (MFR): 6 g/10 min, JIS A hardness: 79°], 80 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3 parts by weight with respect to 100 parts by weight of the resin. After the carbon dioxide gas was sufficiently saturated, the resultant was cooled to a temperature suitable for foaming and then extruded from a die to provide a sheet-shaped resin foam C having a thickness of 1.8 mm.

In this foam, the apparent density was 0.07 g/cm³, the residue at 650° C. was 34%, the tensile modulus of elasticity was 0.6 MPa, and the stress retention ratio was 75%. The evaluation results of the resin foam C including those results are shown in Table 1.

### Example 4

32.5 Parts by weight of polypropylene [melt flow rate (MFR) (230° C.) : 0.40 g/10 min], 32.5 parts by weight of polypropylene [melt flow rate (MFR) (230° C.): 1.1 g/10 min], 35 parts by weight of a polyolefin-based elastomer [melt flow rate (MFR): 6 g/10 min, JIS A hardness: 79°], 120 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3.5 parts by weight with respect to 100 parts by weight of the resin. After the carbon dioxide gas was sufficiently saturated, the resultant was cooled to a temperature suitable for foaming and then extruded from a die to provide a sheet-shaped resin foam D having a thickness of 2.0 mm.

In this foam, the apparent density was 0.07 g/cm³, the residue at 650° C. was 45%, the tensile modulus of elasticity was 0.71 MPa, and the stress retention ratio was 63%. The evaluation results of the resin foam D including those results are shown in Table 1.

### Example 5

A resin foam E having an apparent density of 0.3 g/cm³, a residue at 650° C. of 10%, a tensile modulus of elasticity of 2.4 MPa, and a stress retention ratio of 65% and containing polyethylene as a main component was prepared. The evaluation results of the resin foam E are shown in Table 1.

### Comparative Example 1

22.5 Parts by weight of polypropylene [melt flow rate (MFR) (230° C.): 0.40 g/10 min], 22.5 parts by weight of polypropylene [melt flow rate (MFR) (230° C.): 1.1 g/10 min], 55 parts by weight of a polyolefin-based elastomer [melt flow rate (MFR): 6 g/10 min, JIS A hardness: 79°], 10 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 5.5 parts by weight with respect to 100 parts by weight of the resin. After the carbon dioxide gas was sufficiently saturated, the resultant was cooled to a temperature suitable for foaming and then extruded from a die to provide a sheet-shaped resin foam having a thickness of 1.8 mm. The resin foam was allowed to pass through between a pair of rolls (gap between the rolls) one of which was heated to 200° C., to thereby provide a resin foam F having a thickness of 0.15 mm. The gap between the rolls was set so that the resin foam F having a thickness of 0.15 mm was obtained.

In this foam, the apparent density was 0.07 g/cm³, the residue at 650° C. was 14%, the tensile modulus of elasticity was 0.55 MPa, and the stress retention ratio was 56%. The evaluation results of the resin foam F including those results are shown in Table 1.

TABLE 1

| | | | | | | Com- |
|---|---|---|---|---|---|---|
| | | | | | | parative |
| | Example | Example | Example | Example | Example | Example |
| | 1 | 2 | 3 | 4 | 5 | 1 |
| Apparent | 0.085 | 0.18 | 0.07 | 0.07 | 0.3 | 0.07 |
| density | | | | | | |
| [g/m³] | | | | | | |
| 50% | 9 | 13 | 3.5 | 6 | 20 | 3.5 |
| com- | | | | | | |
| pression | | | | | | |
| load | | | | | | |
| [N/cm²] | | | | | | |
| Tensile | 1.6 | 2.1 | 0.6 | 0.71 | 2.4 | 0.55 |
| modulus | | | | | | |
| of | | | | | | |
| elasticity | | | | | | |
| [MPa] | | | | | | |
| Stress | 70 | 66 | 75 | 63 | 65 | 56 |
| retention | | | | | | |
| ratio [%] | | | | | | |
| R: Residue | 36 | 36 | 34 | 45 | 10 | 14 |
| at 650° C. | | | | | | |
| of foam | | | | | | |
| [wt%] | | | | | | |
| {(100 − | 7.53 | 3.56 | 9.43 | 7.86 | 3.00 | 12.29 |
| R)/D}/100 | | | | | | |
| Cell | 80 | 70 | 90 | 70 | 90 | 75 |
| diameter | | | | | | |
| [μm] | | | | | | |
| Coef- | 0.3 | 0.32 | 0.4 | 0.4 | 0.4 | 0.4 |
| ficient of | | | | | | |
| variation | | | | | | |
| in cell | | | | | | |
| diameter | | | | | | |
| Cell ratio | 91.5 | 82 | 93 | 93 | 70 | 93 |
| [%] | | | | | | |
| Dimens- | 0.8 | 0.3 | 0.9 | 0.8 | 0.3 | 5 |
| ional | | | | | | |
| change | | | | | | |
| ratio at | | | | | | |
| 120° C. | | | | | | |
| [%] | | | | | | |
| Stress | A | A | A | A | B | B |
| dispersi- | | | | | | |
| bility | | | | | | |
| [%] | | | | | | |

It is understood from the results of the dimensional change ratio at 120° C. that the resin composition of the present invention is excellent in heat resistance. In addition, the resin composition of the present invention is excellent in stress dispersibility as well as in heat resistance.

### INDUSTRIAL APPLICABILITY

The resin foam of the present invention can be suitably applied, for example, as a cushioning material for an electronic device.

### REFERENCE SIGNS LIST

1000 stress relaxation tester

100 iron support

200 polycarbonate plate

300 stress measurement film

400 resin foam structure

500 double-sided adhesive tape

600 spacer

700 ABS plate

800 iron ball

1. A resin foam having cell structures,
wherein the resin foam has an apparent density of from 0.05 g/cm³ to 0.50 g/cm³,
wherein the resin foam has a 50% compression load of from 2.0 N/cm² to 30 N/cm², and
wherein the resin foam has an apparent density D (g/cm³) and a residue R (%) at 650° C. satisfying a relationship of the following expression (1).
1≤{(100−R)/D}/100≤10 (1)

2. The resin foam according to claim 1, wherein the cell structures have an average cell diameter of from 10 μm to 200 μm.

3. The resin foam according to claim 1, wherein the cell structures have a coefficient of variation in cell diameter of 0.5 or less.

4. The resin foam according to claim 1 wherein the cell structure has a cell ratio of 30% or more.

5. The resin foam according to claim 1, wherein the cell structure has a thickness of a cell wall of from 0.1 μm to 10 μm.

6. The resin foam according to claim 1, wherein the resin foam has a tensile modulus of elasticity at 23° C. of 0.6 MPa or more.

7. The resin foam according to claim 1, wherein the resin foam has a stress retentivity of 60% or more.

8. The resin foam according to claim 1, wherein the resin foam contains a filler.

9. The resin foam according to claim 8, wherein the filler is an inorganic material.

10. The resin foam according to claim 8, wherein the filler is an organic material.

11. The resin foam according to claim 1, wherein a resin forming the resin foam is a polyolefin-based resin.

12. The resin foam according to claim 11, wherein the polyolefin-based resin is a mixture of polypropylene other than a polyolefin-based elastomer and the polyolefin-based elastomer.

13. The resin foam according to claim 1, wherein the resin foam has a hot-melt layer on one surface or both surfaces thereof.

14. A foam member, comprising:
a resin foam layer formed of the resin foam of claim 1; and
a pressure-sensitive adhesive layer arranged on at least one side of the resin foam layer.
